(19) United States
(12) Patent Application Publication
(10) Pub. No.: US 2014/0160106 A1
(43) Pub. Date: Jun. 12, 2014

(54) DISPLAY CONTROLLER AND APPARATUSES INCLUDING THE SAME

(71) Applicant: Samsung Electronics Co., Ltd., Suwon-Si (KR)

(72) Inventors: Hong Mi CHOI, Hwaseong-si (KR); Jae Sop KONG, Gwacheon-si (KR); Kyoung Man KIM, Suwon-si (KR)

(73) Assignee: Samsung Electronics Co., Ltd., Suwon-Si (KR)

(21) Appl. No.: 14/021,025

(22) Filed: Sep. 9, 2013

(30) Foreign Application Priority Data
Dec. 11, 2012 (KR) 10-2012-0143410

(51) Int. Cl. G09G 3/36

(52) U.S. Cl. CPC G09G 3/3696
USPC 345/212

(57) ABSTRACT

A display controller includes at least one first power domain configured to receive power according to a type of image data, and at least one second power domain configured to receive power regardless of the type of the image data.

### CROSS-REFERENCE TO RELATED APPLICATIONS

This application claims priority under 35 U.S.C. §119(a) from Korean Patent Application No. 10-2012-0143410 filed on Dec. 11, 2012, the disclosure of which is hereby incorporated by reference in its entirety.

### BACKGROUND

The present inventive concepts relate to a display controller which may individually control a power state of a plurality of power domains in the display controller, a system on chip (SoC) including the display controller, and devices including the display controller.

System on chip (SoC) denotes a technology integrating various functional blocks such as a central processing unit (CPU), a memory, an interface, a digital signal processing circuit, and an analog signal processing circuit on a semiconductor integration circuit to embody a computer system, or an integrated circuit (IC) integrated according to the technology.

SoC technology has been deployed in more complicated systems including various functions such as a processor, a multimedia, a graphic, an interface, and security.

In addition, the SoC technology is used in portable devices having a battery, so that the SoC includes a circuit for properly managing power consumed in the SoC, i.e., a power management unit (PMU). In order to reduce power consumption of the SoC, a method of efficiently managing a power of a display controller included in the SoC may be required to reduce the power consumption of the SoC.

### SUMMARY

An example embodiment is directed to a display controller, including at least one first power domain powered on/off according to a type of image data, and at least one second power domain supplied with a power all the time regardless of the type of the image data.

According to an example embodiment, the display controller may further include a power supply control circuit independently controlling a power supplied to the at least one first power domain and the at least one second power domain based on switch signals dependent on the type of the image data.

When the type of the image data is dynamic image data, the dynamic image data are processed through the at least one first power domain and the at least one second power domain. When the type of the image data is static image data, the static image data are processed through the at least one second power domain.

The at least one first power domain includes an image processing circuit for processing the image data, and the at least one second power domain includes a transmission interface for transmitting the processed image data to a display.

The SoC according to an example embodiment of the present inventive concepts includes a display controller including a plurality of power domains, a central processing unit (CPU) generating a control signal according to a type of image data, and a power management unit (PMU) controlling each power state of the plurality of power domains in response to the control signal.

When a type of the image data is dynamic image data, each of the plurality of power domain is powered on. When a type of the image data is static image data, at least one of the plurality of power domains is powered off.

When a display module connected to the SoC supports a panel self refresh (PSR), the plurality of power domains are powered off. The plurality of power domains include a first power domain and a second power domain.

The first power domain includes an image processing circuit processing the image data, and the second power domain includes a transmission interface transmitting the processed image data.

When a type of the image data is dynamic image data, the first power domain and the second power domain are powered-on. When the type of the image data is static image data, the first power domain is powered off and the second power domain is powered off. The image data having different types are processed through different data paths determined according to each power state of the plurality of power domains.

An example embodiment of the present inventive concepts is directed to a system, including the SoC and a display module connected to the SoC.

The image data having different types are processed through different data paths determined by each power state of the plurality of power domains. The plurality of power domains include a first power domain and a second power domain.

When a type of the image data is dynamic image data, the first power domain and the second power domain are powered on. When a type of the image data is static image data, the first power domain is powered off, and the second power domain is powered on.

According to an example embodiment, the system may further include an external memory receiving and storing image data processed by an image processing circuit included in the first power domain.

The processed image data stored in the external memory are transmitted to the second power domain. The first power domain may include a first direct memory access (DMA) module which is connected to the image processing circuit and is for accessing the external memory storing the image data to be processed.

The second power domain includes a second DMA module for accessing the external memory storing the processed image data, a transmission interface for transmitting the processed image data output from the second DMA module to the display module, and a timing controller controlling the image processing circuit, the first DMA module, the second DMA module, and the transmission interface.

An example embodiment of the present inventive concepts is directed to a method of operating a display controller, including receiving a control signal determined according to a type of image data, and controlling a power state of each of a plurality of power domains independently power-gated in response to the control signal.

According to an example embodiment, the method of operating the display controller may further include processing the image data having different types through different data paths determined according to a power state of each of the plurality of power domains.

In the controlling, when a type of the image data is dynamic image data, each of the plurality of power domains is controlled to be powered on. In the controlling, when a type of the image data is static image data, at least one of the plurality of power domains is controlled to be powered off.

In the controlling, transmitting the static image data processed by an image processing device to an external memory, and controlling a power domain including the image processing device among the plurality of power domains to be powered off.

An example embodiment of the present inventive concepts is directed to a method of operating a SoC, including determining a type of image data and generating a control signal based on a result of the determination in a CPU, and controlling a power state of each of a plurality of power domains which are included in a display controller in response to the control signal and independently power-gated in a PMU.

According to an example embodiment, the method of operating the SoC may further include processing the image data having different types through different data paths determined according to a power state of each of the plurality of power domains.

When a type of the image data is dynamic image data in the display controller, each of the plurality of power domains is controlled to be powered on so as to form a first data path for processing the dynamic image data.

When a type of the image data is static image data, at least one of the plurality of power domains is controlled to be powered off so as to form a second data path for processing the static image data.

At least one example embodiment relates to a system on chip.

In one embodiment, the system on chip includes a memory controller configured to read image data having a data type; a display controller including a plurality of power domains configured to selectively process the image data and transmit the image data to a display module based on switch signals; and a power management unit configured to generate the switch signals based on the data type.

In one embodiment, the power management unit is configured to control which of the plurality of power domains are included in a data path between the memory controller and the display module based on the data type.

In one embodiment, the system on chip includes a central processing unit configured to determine the data type, wherein the power management unit is configured to instruct the display controller to communicate the image data between the memory controller and the display module via a data path that includes the power domains having image processing circuits, if the determined data type is dynamic image data, and the power management unit is configured to instruct the display controller to disable the power domains that include image processing circuits and communicate the image data between the memory controller and the display module via a data path that does not include the power domains having the image processing circuits, if the determined data type is static image data.

In one embodiment, the power management unit is further configured to instruct the display controller to disable the plurality of power domains including both the power domains having the image processing units and the power domains that do not have the image processing units, if the display module is configure to support panel self-refresh (PSR) and the determined data type is the static image data.

In one embodiment, the display controller includes a first power domain including an image processing circuit configured to process the image data; and a second power domain including a transmission interface configured to transmit the processed image data to the display module.

In one embodiment, the first power domain consumes more power than the second power domain.

### BRIEF DESCRIPTION OF THE DRAWINGS

These and/or other aspects and advantages of the present inventive concepts will become apparent and more readily appreciated from the following description of the embodiments, taken in conjunction with the accompanying drawings of which:

FIG. 1 is a block diagram of a system including a system on chip according to an example embodiment of the present inventive concepts;

FIG. 2 is a block diagram of a power management unit (PMU) illustrated in FIG. 1;

FIG. 3 is a block diagram for describing an example embodiment of an operation of the system on chip illustrated in FIG. 1;

FIG. 4 is a block diagram for describing another example embodiment of the operation of the system on chip illustrated in FIG. 1;

FIG. 5 is a flowchart for describing an operation of the system on chip illustrated in FIG. 1,

FIG. 6 is a flowchart for describing an operation of a display controller illustrated in FIG. 1; and

FIG. 7 is another block diagram of a system including the system on chip according to an example embodiment of the present inventive concepts.

### DETAILED DESCRIPTION OF THE EMBODIMENTS

The present inventive concepts now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

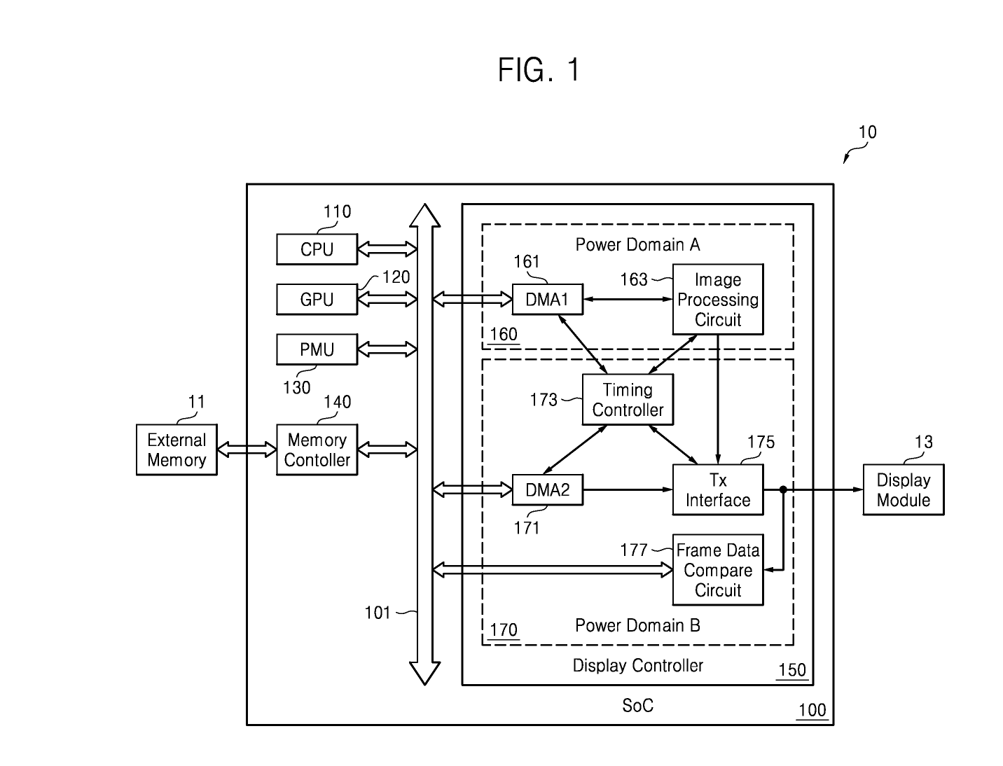

FIG. 1 is a block diagram of a system including a system on chip according to an example embodiment of the present inventive concepts.

Referring to FIG. 1, a system 10 may be embodied in a portable electronic device such as a mobile phone, a smart phone, a tablet PC, a personal digital assistant (PDA), a portable multimedia player (PMP), a MP3 player, a MP4 player, an E-book, or a mobile internet device (MID).

The system 10 may include an external memory 11, a system on chip (SoC) 100, and a display module 13. According to an example embodiment, the system 10 may further include other components, e.g., a camera interface.

The external memory 11 stores program instructions performed in a central processing unit (CPU) 110. In addition, the external memory 11 may store image data for displaying still images or moving images in the display module 13. The moving images are a series of different still images presented within a short period of time.

A type of the image data may be static image data or dynamic image data. The static image data is used to display the still images in the display module 13. The dynamic image data is used to display the moving images in the display module 13.

The external memory 11 may be a volatile memory or a non-volatile memory. The volatile memory may be a dynamic random access memory (DRAM), a static random access memory (SRAM), a thyristor RAM (T-RAM), a zero capacitor RAM (Z-RAM), or a Twin Transistor RAM (TTRAM). The non-volatile memory may be an Electrically Erasable Programmable Read-Only Memory (EEPROM), a flash memory, a Magnetic RAM (MRAM), a Phase Change RAM (PRAM), or a resistive RAM (RRAM).

The SoC 100 controls the external memory 11 and the display module 13. According to an example embodiment, the SoC 100 may be referred to as an integrated circuit (IC), a processor, an application processor, a multimedia processor, or an integrated multimedia processor.

The SoC 100 may include the central processing unit (CPU) 110, a graphic processing unit (GPU) 120, a power management unit (PMU) 130, a memory controller 140, and a display controller 150. Each component 110, 120, 130, 140, and 150 communicates with each other through a bus 101.

The CPU 110 reads and executes program instructions so as to generally control an operation of the SoC 100. For example, the program instructions may be program instructions for the CPU 110 to determine a type of image data and to control the PMU 130 according to the determination. The CPU 110 may generate a control signal for controlling the PMU 130 by executing the program instructions.

The display controller 150 includes a plurality of power domains 160 and 170 that controls image display via the display module 13 and provides the CPU with the second interrupt signal generated based on the type of image data.

When the CPU 110 does not receive a first interrupt signal for changing a still image to be displayed in the display module 13 for a certain period of time, the CPU 110 determines that image data are static image data.

On the contrary, when the CPU 110 receives the first interrupt signal for changing still image displayed in the display module 13 within a certain period of time, the CPU 110 determines that the image data are dynamic image data. The first interrupt signal may be generated by a user's request (e.g., a touch input). The SoC 100 may further include an input interface (not shown) for receiving the user's request.

According to an example embodiment, when the CPU 110 does not receive a second interrupt signal output from a frame data comparison circuit 177 within a certain period of time, the CPU 110 determines that the image data are static image data. An operation of the frame data comparison circuit 177 will be described in detail as follows.

When the CPU 110 receives the second interrupt signal output from the frame data comparison circuit 177 within a certain period of time, the CPU 110 determines that the image data are dynamic image data. The image data are output from the external memory 11. According to an example embodiment, the image data may be output from an image sensor (not shown). The image sensor may be connected to the SoC 100.

In addition, according to an example embodiment, the CPU 110 may be embodied in a multi-core. The multi-core is a computing component having two or more independent cores.

The GPU 120 may read and execute program instructions related to graphic processing. The GPU 120 is used to reduce loads of the CPU 110.

The PMU 130 manages power of each component 110, 120, 140, and 150 of the SoC 100. Moreover, the PMU 130 may control each power state of the plurality of power domains 160 and 170 in the display controller 150 in response to a control signal output from the CPU 110.

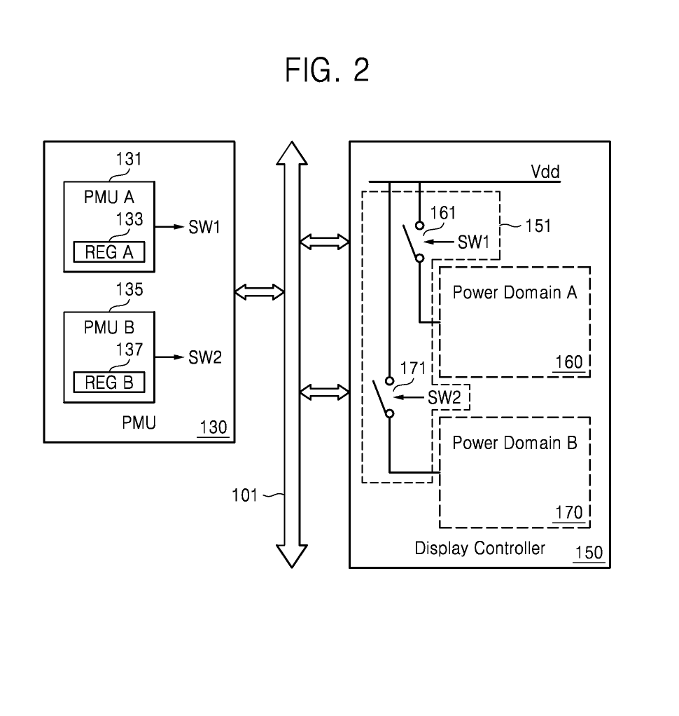

The power state denotes a power-up state (or a power-on state) or a power-down state (or a power-off state). The power-up state denotes a state in which a power or a voltage of the power domain 160 or 170 is fully up. The power-down state denotes a state in which a power of the power domain 160 or 170 is off or a state entering in a low-power mode. A detailed operation of the PMU 130 will be described in detail in FIGS. 2 to 5.

The memory controller 140 may transmit image data, e.g., static image data or dynamic image data, output from the external memory 11 to the display controller 150 through a bus 101.

The display controller 150 includes a plurality of direct memory access (DMA) modules 161 and 171, an image processing circuit 163, a timing controller 173, a transmission interface 175, and a frame data comparison circuit 177.

The plurality of DMA modules 161 and 171 receive image data from the external memory 11 through the memory controller 140 without using the CPU 110.

The image processing circuit 163 receives image data from the first DMA module 161 and performs various image processing operations. For example, the image processing circuit 163 performs operations such as color space conversion, blending, 3D merging, or image enhancement.

The timing controller 173 controls timing of each component 161, 163, 171, and 175.

The transmission interface 175 transmits image data output from the image processing circuit 163 or the second DMA module 171 to the display module 13. Image data output from the transmission interface 175 may be embodied in data or data packet suitable for a protocol of the transmission interface 175.

According to an example embodiment, the transmission interface 175 may be embodied in a CPU interface, a RGB interface, or a serial interface. According to another example embodiment, the transmission interface 175 may be embodied in a mobile display digital interface (MDDI), a mobile industry processor interface (MIPI®), a serial peripheral interface (SPI), an inter IC (I²C) interface, a displayport (DP), or an embedded displayport (eDP).

The frame data comparison circuit 177 compares current image data output from the transmission interface 175 with previous image data. When the current frame equals to the previous frame, the frame data comparison circuit 177 may transmit a second interrupt signal to the CPU 110.

The first power domain 160 may include the first DMA module 161 and the image processing circuit 163, and the second power domain 170 may include the second DMA module 171, the timing controller 173, and the transmission interface 175.

According to an example embodiment, the display controller 150 may be divided into at least two power domains.

It is illustrated that the frame data comparison circuit 177 of FIG. 1 is included in a second power domain 170; however, the frame data comparison circuit 177 may be included in the first power domain 160 according to an example embodiment. According to still another example embodiment, the frame data comparison circuit 177 may be included in other power domains in addition to the first power domain 160 and the second power domain 170.

The display module 13 displays image data processed by the SoC 100. That is, the display module 13 displays still images or moving images. The display module 13 includes a display and a display driver for driving the display.

The display may be a liquid crystal display (LCD), a light emitting diode (LED) display, an organic light emitting diode (OLED) display, an active-matrix organic light-emitting diode (AMOLED) display, or a flexible display.

FIG. 2 is a block diagram of the power management unit (PMU) illustrated in FIG. 1.

Referring to FIGS. 1 and 2, the PMU 130 includes a first sub PMU 131 and a second sub PMU 135. The first sub PMU 131 generates a first switch signal SW1 in response to a control signal output from the CPU 110 so as to control a power state of the first power domain 160. The first sub PMU 131 may include a first register 133.

The first register 133 is a configuration register, and may be configured in response to a control signal output from the CPU 110. The first switch signal SW1 is generated according to the first register 133. Similarly, a second sub PMU 135 generates a second switch signal SW2 in response to a control signal output from the CPU 110 so as to control a power state of the second power domain 170. The second sub PMU 135 may include a second register 137.

The second register 137 is a configuration register, and may be configured in response to a control signal output from the CPU 110. The second switch signal SW2 is generated according to the second register 137.

The display controller 150 may include a power supply control circuit 151 that independently controls a power supplied to the first power domain 160 and the second power domain 170 based on switch signals SW1 and SW2 dependent on the type of the image data. The power supply control circuit 151 includes switches 161 and 171. Each of the switches 161 and 171 may be embodied in an NMOS transistor or a PMOS transistor.

A power state of the first power domain 160 is controlled according to the first switch signal SW1 output from the first sub PMU 131. A power state of the second power domain 170 is controlled according to the second switch signal SW2 output from the second sub PMU 135. Each of the switches 161 and 171 may supply a voltage Vdd to each of the power domains 160 and 170 in response to each of the switch signals SW1 and SW2. The second power domain 170 may be supplied with a power all the time regardless of the type of the image data.

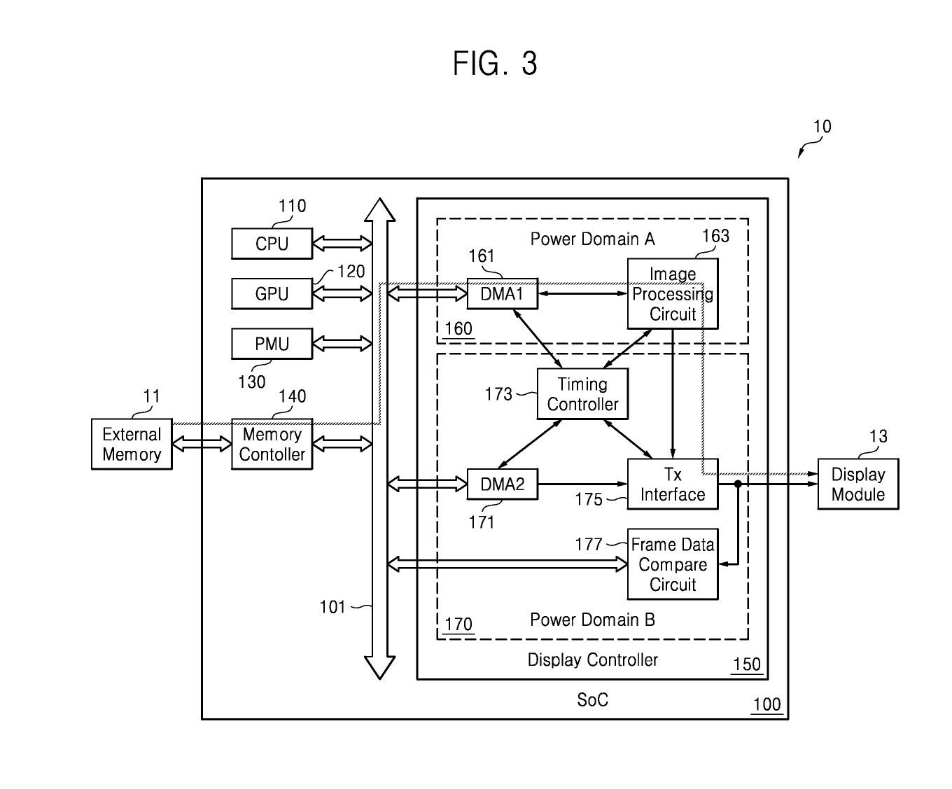

FIG. 3 is a block diagram for describing an example embodiment of an operation of the system on chip illustrated in FIG. 1.

Referring to FIGS. 1 to 3, when the CPU 110 determines that a type of image data output from the external memory 11 is dynamic image data, each of the power domains 160 and 170 is powered on.

The first DMA module 161 receives the dynamic image data output from the external memory 11. The image processing circuit 163 performs various image processing operations for the dynamic image data. The dynamic image data processed by the image processing circuit 163 are transmitted to the display module 13 through the transmission interface 175.

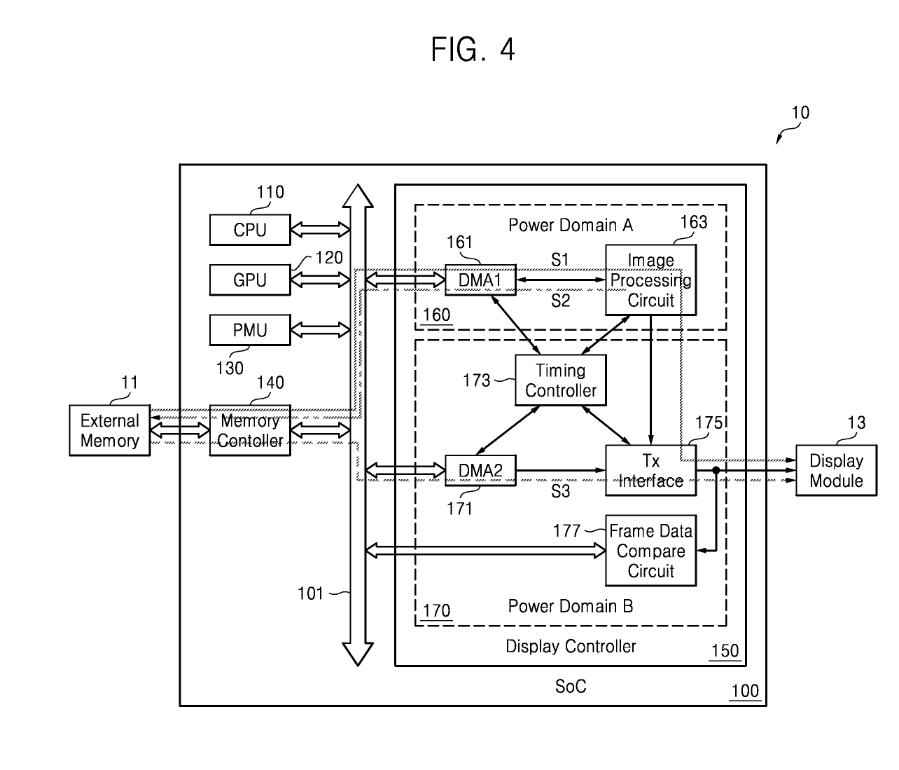

FIG. 4 is a block diagram for describing another example embodiment of the operation of the system on chip illustrated in FIG. 1.

Referring to FIGS. 1, 2, and 4, when the CPU 110 determines that the type of the image data output from the external memory 11 is static image data, the first DMA module 161 receives the static image data output from the external memory 11. The image processing circuit 163 performs various image processing operations for the static image data. The static image data processed by the image processing circuit 163 are transmitted to the display module 13 through the transmission interface 175 (S1).

The display module 13 needs to display a series of the same images at a fixed rate so as to display still images in the display module 13.

After the static image data processed by the image processing circuit 163 are transmitted to the display module 13 through the transmission interface 175, the static image data are transmitted to the external memory 11 through the first DMA module 161 and the memory controller 140 (S2).

After the external memory 11 stores the static image data, at least one of the power domains 160 and 170 is powered off. For example, the first power domain 160 is powered off, and the second power domain 170 is powered on.

The second DMA module 171 receives the static image data stored in the external memory 11 through the memory controller 140. The static image data are data processed in advance by the image processing circuit 163. The static image data are transmitted to the display module 13 through the transmission interface 175 so that the display module 13 may display still images (S3).

The SoC 100 may not use the first power domain 160, thereby effectively managing a power. According to an example embodiment, the CPU 110 may determine that the type of the image data output from the external memory 11 is changed from the dynamic image data to the static image data.

When the type of the data is changed from the dynamic image data to the static image data, the dynamic image data processed by the image processing circuit 163 are transmitted to the display module 13 through the transmission interface 175, and then the dynamic image data are transmitted to the external memory 11 through the first DMA module 161 and the memory controller 140.

After the external memory 11 stores the dynamic image data, the first DMA module 161 receives static image data from the external memory 11. The image processing circuit 163 performs various image processing operations for the static image data. The static image data processed by the image processing circuit 163 are transmitted to the display module 13 through the transmission interface 175.

After the static image data processed by the image processing circuit 163 are transmitted to the display module 13 through the transmission interface 175, the static image data are transmitted to the external memory 11 through the first DMA module 161 and the memory controller 140.

After the external memory 11 stores the processed static image data, at least one of the power domains 160 and 170 is powered off. For example, the first power domain 160 is powered off, and the second power domain 170 is powered on.

According to still another example embodiment, the display module 13 may support a panel self refresh (PSR). When the display module 13 displays still images, PSR technology may be used to save a power. In order to use the PSR technology, the display module 13 includes a memory (e.g., a frame buffer). When the display module 13 displays still images, the memory included in the display module 13 stores static image data lastly transmitted from the transmission interface 175. The display module 13 may display still images by using the static image data stored in the memory.

Accordingly, the power domains 160 and 170 may be powered off in the display controller 150.

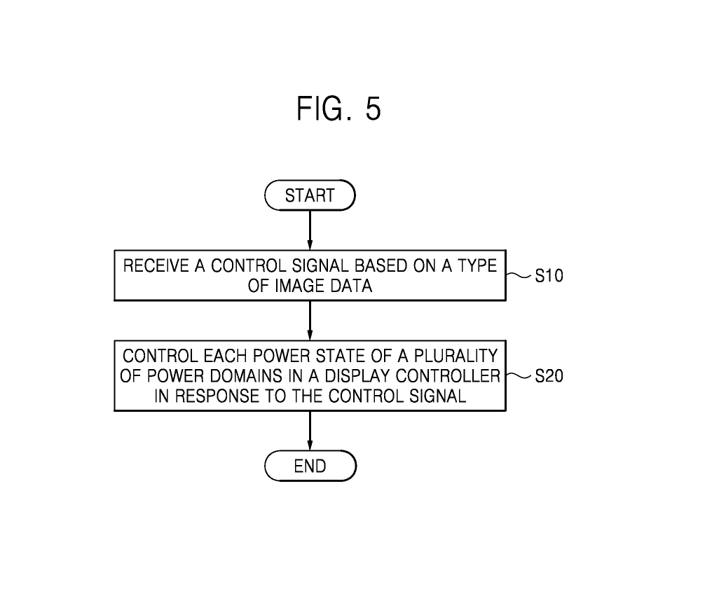

FIG. 5 is a flowchart for describing an operation of the system-on-chip illustrated in FIG. 1.

Referring to FIGS. 1 and 5, the PMU 130 receives a control signal from the CPU 110 based on a type of image data (S10). The CPU 110 executes program instructions so as to determine the type of the image data output from the external memory 11, and generates the control signal based on the determination.

The PMU 130 controls each power state of the plurality of power domains 160 and 170 in the display controller 150 in response to the control signal output from the CPU 110 (S20).

When the type of the data is dynamic image data, each of the plurality of power domains 160 and 170 is powered on. When the type of the data is static image data, at least one of the plurality of power domains 160 and 170 is powered off. Data in the display controller 150 are transmitted have different data paths according to a data type of the image data (e.g. static or dynamic).

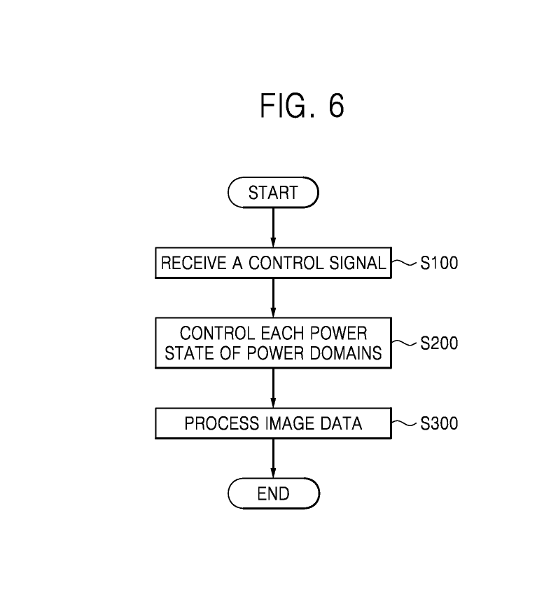

FIG. 6 is a flowchart for describing an operation of the display controller illustrated in FIG. 1.

Referring to FIGS. 1 and 6, the display controller 150 receives the control signal determined according to the data type of image data from the CPU 110 (S 100).

The power supply control circuit 151 controls each power state of the plurality of power domains 160 and 170 independently power-gated in response to switch signals SW1 and SW2 (S200). The switch signals SW1 and SW2 are determined according to the control signal.

When the type of the image data is dynamic image data, each of the plurality of power domains 160 and 170 is powered on. When the type of the image data is static image data, at least one, e.g., 160, of the plurality of power domains 160 and 170 is powered off.

The display controller 150 processes the image data having different types through different data paths determined according to each power state of the plurality of power domains 160 and 170 (S300). When the type of the image data is dynamic image data, a data path is illustrated as in FIG. 3. When the type of the image data is static image data, a data path is illustrated as in FIG. 4.

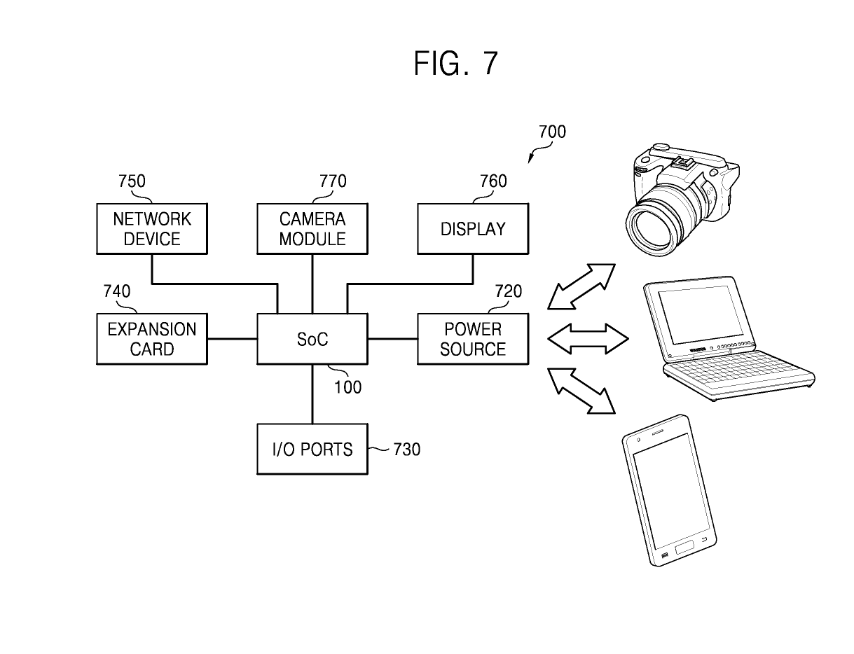

FIG. 7 is another block diagram of a system including the system on chip according to an example embodiment of the present inventive concepts.

The system 700 may include the SoC 100, a power source 720, input/output ports 730, an expansion card 740, a network device 750, and a display 760. According to an example embodiment, the system 700 may further include a camera module 770. The SoC 100 may control an operation of at least one of components 720 to 770. The SoC 100 corresponds to the SoC 100 illustrated in FIG. 1.

The power source 720 may supply an operation voltage to at least one of components 100 and 730 to 770.

The input ports 730 denote ports transmitting data to the system 700 or transmitting data output from the system 700 to an external device.

The expansion card 740 may be embodied in a secure digital (SD) card or a multimedia card (MMC). According to an example embodiment, the expansion card 740 may be a Subscriber Identification Module (SIM) card or a Universal Subscriber Identity Module (USIM) card.

The network device 750 may denote a device connecting the system 700 to a wireless network.

The display 760 may display data output from the input/output ports 730, the expansion card 740, or the network device 750. The display 760 corresponds to the display module 13 illustrated in FIG. 1. The display 760 may be referred to as a display module.

A camera module 770 denotes a module converting an optical image into an electrical image. Accordingly, an electrical image output from the camera module 770 may be stored in the SoC 100 or the expansion card 740. In addition, an electrical image output from the camera module 770 may be displayed through the display 760 according to a control of the SoC 100. The camera module 770 includes an image sensor.

A display controller according to an example embodiment of the present inventive concepts and devices having the same may efficiently manage a power consumed in a system-on-chip including the display controller by individually controlling a power state of a plurality of power domains embodied in the display controller according to a type of image data.

While the present inventive concepts have been particularly shown and described with reference to example embodiments thereof, it will be understood by those of ordinary skill in the art that various changes in forms and details may be made therein without departing from the spirit and scope of the present inventive concepts as defined by the following claims.

What is claimed is:

1. A display controller comprising:
at least one first power domain configured to receive power according to a type of image data; and
at least one second power domain configured to receive power regardless of the type of the image data.

2. The display controller of claim 1, wherein the display controller further comprises:
a power supply control circuit configured to independently control the power supplied to the at least one first power domain and the at least one second power domain based on switch signals that vary based on the type of the image data.

3. The display controller of claim 1, wherein,
the at least one first power domain and the at least one second power domain are both configured to process the image data, when the type of the image data is dynamic image data, and
the at least one second power domain is configured to process the image data, when the type of the image data is static image data.

4. The display controller of claim 1, wherein the at least one first power domain comprises:
an image processing circuit configured to process the image data, and the at least one second power domain includes a transmission interface configured to transmit the processed image data to a display.

5. A system on chip (SoC) comprising:
a display controller including a plurality of power domains;
a central processing unit (CPU) configured to generate a control signal according to a type of image data; and
a power management unit (PMU) controlling a power state of the plurality of power domains in response to the control signal.

6. The SoC of claim 5, wherein, each of the plurality of power domains is configured to receive power, when the type of the image data is dynamic image data.

7. The SoC of claim 5, wherein, at least one of the plurality of power domains is configured to not receive power, when the type of the image data is static image data.

8. The SoC of claim 5, wherein, the plurality of power domains are configured to not receive power, if a display module connected to the SoC supports panel self-refresh (PSR) and the type of the image data is static image data.

9. The SoC of claim 5, wherein the plurality of power domains comprise:
a first power domain and a second power domain, the first power domain including an image processing circuit configured to process the image data, and the second power domain including a transmission interface configured to transmit the processed image data.

10. The SoC of claim 9, wherein, the first power domain and the second power domain are both configured to receive power when the type of the image data is dynamic image data.

11. The SoC of claim 9, wherein, the first power domain is configured to not receive power, and the second power domain is configured to receive power when the type of the image data is static image data.

12. The SoC of claim 5, wherein the image data having different types are processed through different data paths determined according to the power state of the plurality of power domains.

13. A system comprising:
the SoC of claim 5; and
a display module connected to the SoC.

14. The system of claim 13, wherein the image data having different types are processed through different data paths determined according to the power state of the plurality of power domains.

15. The system of claim 13, wherein the plurality of power domains comprise:
a first power domain and a second power domain, the first power domain and the second power domain are both configured to receive power when the type of the image data is dynamic image data, and
the first power domain is configured to not receive power and the second power domain is configured to receive power when the type of the image data is static image data.

16. A system on chip comprising:
a memory controller configured to read image data having a data type;
a display controller including a plurality of power domains configured to selectively process the image data and transmit the image data to a display module based on switch signals; and
a power management unit configured to generate the switch signals based on the data type.

17. The system on chip of claim 16, wherein the power management unit is configured to control which of the plurality of power domains are included in a data path between the memory controller and the display module based on the data type.

18. The system on chip of claim 16, further comprising:
a central processing unit configured to determine the data type, wherein
the power management unit is configured to instruct the display controller to communicate the image data between the memory controller and the display module via a data path that includes the power domains having image processing circuits, if the determined data type is dynamic image data, and
the power management unit is configured to instruct the display controller to disable the power domains that include image processing circuits and communicate the image data between the memory controller and the display module via a data path that does not include the power domains having the image processing circuits, if the determined data type is static image data.

19. The system on chip of claim 18, wherein the power management unit is further configured to instruct the display controller to disable the plurality of power domains including both the power domains having the image processing units and the power domains that do not have the image processing units, if the display module is configure to support panel self-refresh (PSR) and the determined data type is the static image data.

20. The system on chip of claim 16, wherein the display controller comprises:
a first power domain including an image processing circuit configured to process the image data; and
a second power domain including a transmission interface configured to transmit the processed image data to the display module, wherein the first power domain consumes more power than the second power domain.
